(19) United States
(12) Patent Application Publication
(10) Pub. No.: US 2007/0072448 A1
(43) Pub. Date: Mar. 29, 2007

(54) Apparatus and method for loading a socket or adapter device with a semiconductor component

(76) Inventors: Holger Hoppe, Mering (DE); Abel Nogueira, Braga (PT); Fernando Teixeira, Leca Da Palmeira (PT)

Correspondence Address: BAKER BOTTS, L.L.P., 98 SAN JACINTO BLVD., SUITE 1500, AUSTIN, TX, 78701-4039, US

(21) Appl. No.: 11/536,428

(22) Filed: Sep. 28, 2006

(30) Foreign Application Priority Data
Sep. 29, 2005 (DE) 10 2005 046 736

(51) Int. Cl. H01R 12/00

(52) U.S. Cl. 439/71

(57) ABSTRACT

In a method and apparatus for loading a socket or adapter device with a semiconductor component, the semiconductor component is guided by at least one first guide element of the apparatus to the socket or adapter device in such a way that contact is made with the semiconductor component by means of the contact elements, and to an apparatus for loading a first socket or adapter device with a semiconductor component, the apparatus having one or more guide elements for producing an electrical contact between the semiconductor component and the contact elements of the first socket or adapter device.

### PRIORITY

This application claims priority from German Patent Application No. DE 10 2005 046 736.9, which was filed on Sep. 29, 2005, and is incorporated herein by reference in its entirety.

### TECHNICAL FIELD

An apparatus and a method for loading a socket or adapter device with a semiconductor component in particular for use when testing a semiconductor component loaded into the socket or adapter device.

### BACKGROUND

After the processing of the semiconductor chips has finished and the semiconductor chips have been packaged in a manner protected by housings (“package”), they are transported further to one or more test stations. These or a plurality of such test stations may be e.g. a so-called “burn-in” station, in particular a “burn-in” test station.

At the “burn-in” station, the semiconductor components—by creating extreme conditions (e.g. elevated temperature and/or operating voltage)—are subjected to artificial aging and tested with regard to their electrical functionality.

At the “burn-in” station, the housings—as will be explained in more detail below—are loaded into corresponding coverless sockets or adapters with the aid of one or more corresponding machines (e.g. a loading machine (“loader”)) as described in DE 10359648.

### SUMMARY

According to an embodiment, an apparatus, in particular a loader head, for loading a first socket or adapter device with a semiconductor component, the first socket or adapter device having contact elements for making contact with the semiconductor component, can be provided, the apparatus having one or more guide elements for producing an electrical contact between the semiconductor component and the contact elements of the first socket or adapter device.

### BRIEF DESCRIPTION OF THE DRAWINGS

The accompanying drawings are included to provide a further understanding of embodiments of the invention, and are incorporated in and constitute a part of this specification. The drawings illustrate some embodiments of the present invention.

FIG. 1 shows a schematic perspective illustration of the loading apparatus, in particular of the “loader head”;

FIG. 2 shows a schematic perspective view of a guide element of the loading apparatus shown in FIG. 1;

FIG. 3 shows an embodiment of a socket or adapter without a cover.

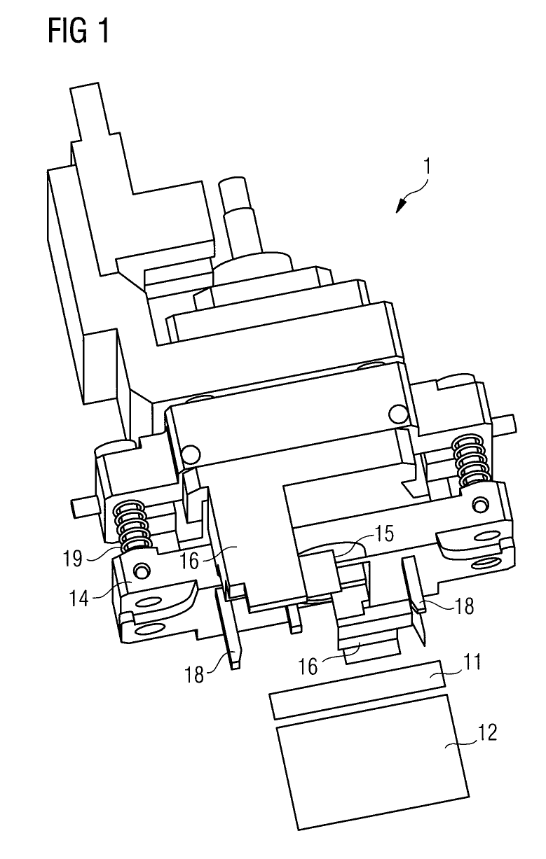

FIG. 1 shows the loader head as a detail from an apparatus for loading a socket or adapter device. It being understood, however, that the invention is not limited to the precise arrangements and/or instrumentalities shown.

### DETAILED DESCRIPTION

The one or more guide elements can be fixed in moveable fashion by means of holding elements on the apparatus. This makes it possible to compensate for slight incorrect positions between the contact elements of the socket or adapter and to prevent damage to the contact elements and/or the electrical connecting contacts of the semiconductor component.

In another embodiment, the holding elements may contain springs. In order to avoid incorrect contact-connection, another embodiment of the apparatus may have guide pins which orient the apparatus during the loading of the first socket or adapter device in a defined position relative to the first socket or adapter device.

In another embodiment, the apparatus may have spacer elements arranged in such a way that, for the one or more guide elements, a minimum distance from the contact elements of the first socket or adapter device is complied with.

In a further embodiment of the apparatus, the one or more guide elements and guide pins can be arranged in such a way that the apparatus is also suitable for removing the semiconductor components from a second socket or adapter device, in particular a test before load station.

According to another embodiment, in a method for loading a socket or adapter device with a semiconductor component, wherein the socket or adapter device having contact elements for making contact with the semiconductor component, the semiconductor component can be guided by at least one guide element of the apparatus to the socket or adapter device in such a way that contact is made with the semiconductor component by means of the contact elements.

By virtue of the guide element/elements being fitted to the loader head, the components, in the course of loading the coverless sockets or adapters, are better oriented to the contact elements in the socket or adapter and are therefore electrically contact-connected more reliably and the coverless sockets or adapters furthermore remain independent of component type and therefore universally useable. Since, in contrast to the covers on each socket or adapter, the guide element/elements need only be fitted to each loader head, the costs for the sockets or adapters can furthermore be kept low whilst at the same time reducing the rate of the incorrectly contact-connected components. It is thereby possible to reduce—overall—the costs arising during the production/testing of semiconductor components.

Semiconductor components, e.g. corresponding integrated (analogue or digital) arithmetic circuits, semiconductor memory components such as e.g. function memory components (PLAs, PALs, etc.) and table memory components (e.g. ROMs or RAMs, in particular SRAMs and DRAMs), etc. are subjected to comprehensive tests in the course of the production process.

In order to jointly produce in each case a multiplicity (e.g. 250 components per wafer) of (generally identical) semiconductor components, a thin slice composed of monocrystalline silicon (a “wafer”) is generally used in each case.

The wafer is subjected, at a plurality of different stations, to a multiplicity (in modern processes far more than a hundred) of coating, exposure, etching, diffusion, and implantation process steps, etc. and is thereupon singulated, e.g. sawn apart, scribed and/or broken, so that the individual components are then available.

After singulation, the components are in each case loaded individually into specific housings or packages (e.g. so-called TSOP or FBGA housings, etc.) and then transported further—e.g. by means of corresponding trays—to a corresponding further station, in particular test station (or successively to a plurality of different test stations).

The abovementioned further stations may be e.g. a so-called “burn-in” station, at which an artificial ageing process of the components is brought about—by creating extreme conditions (e.g. evaluated temperature and/or elevated operating voltage, etc.).

At the (test) station, individual components—situated in the abovementioned housings—are in each case loaded into a corresponding adapter or socket—connected to a corresponding test unit—and the component situated in the respective housing is then tested. In this case, the adapter or socket is formed individually for a single type of component.

The loading of the (burn-in) adapters or sockets with a component to be tested may be effected with the aid of one or more corresponding loading apparatuses (“loaders”).

For this purpose, a vacuum may be generated at a gripping device, e.g. a loader head, provided at a corresponding loading apparatus (“loader”), with the aid of which vacuum a component can be removed from the respective tray and then positioned—by corresponding movement (e.g. pivoting or displacement) of the gripping device or the loader head—above a so-called preciser device.

The component situated above the preciser device can then be dropped from the abovementioned loader gripping device—by removing the vacuum—into a cutout having corresponding insertion bevels that is provided in the preciser device.

What can be achieved by means of the insertion bevels is that the component or the component housing is correspondingly oriented (in preliminary fashion or coarsely) as it falls into the corresponding preciser cutout.

Next, the abovementioned loading apparatus (or a further loading apparatus) can remove the (preliminarily or coarsely) oriented component again from the cutout provided in the preciser device (e.g. by generating a vacuum at the gripping device, or the “loader head”, provided at the abovementioned or the further loading apparatus).

The component can thereupon be positioned—by corresponding movement (e.g. pivoting or displacement) of the gripping device or the loader head—above a array (“burn-in board”) of, for example, 16*20 corresponding (burn-in) adapters or sockets. It is likewise possible to move the burn-in board relative to the loader head in order to load the adapters or sockets.

(Burn-in) adapters or sockets may comprise e.g. a basic element, and a cover—which can be displaced e.g. in the vertical direction relative to the basic element and is mounted on the basic element with the interposition of corresponding spring elements. However, said cover is produced in component-specific fashion. Therefore, each socket with cover is also suitable only for the respective specific type of component.

By correspondingly depressing the adapter or socket cover, the adapter or socket can be “opened” and the component situated above the adapter or socket can then be dropped into the adapter or socket from the abovementioned loader gripping device—by removing the vacuum.

Within the cover, corresponding insertion bevels may be provided which ensure that the component or the component housing is oriented—exactly—as it falls into the adapter.

If the adapter or socket cover is then released again, it is pressed upwards by the abovementioned spring elements, which has the effect that connections provided on the respective component (or component housing) make electrical contact with corresponding connections (generally spring elements) provided on the adapter or socket, that is to say that the adapter or socket is “closed” so that the abovementioned test methods can then be carried out on the component.

Since semiconductor components, e.g. DRAMs, are mass-produced articles (in 2003 approximately 3 billion DRAMs were produced globally), the abovementioned (burn-in) adapters or sockets are required in high numbers even in test methods carried out in parallel.

(Burn-in) adapters or sockets 12 are relatively expensive on account of the complex precision-mechanical construction of the socket basic element and the component-specific cover—which is intended to prevent incorrect contact from being made between the component (or component housing) and adapter or socket connections. Therefore sockets or adapter devices without the component-specific cover on the adapter or socket 12 are introduced. However, the absence of the cover means that the guidance of the components in the course of loading into the adapters or sockets has also been lost. Due to the large number of components to be tested, the cycle rate at which the adapters or sockets are loaded and unloaded by a loading machine is very high (approximately 30,000 loading and unloading operations per hour). The high cycle rate in combination with the lack of guidance due to the absence of the covers can lead to an increase in the rate of incorrectly contact-connected and hence untested components.

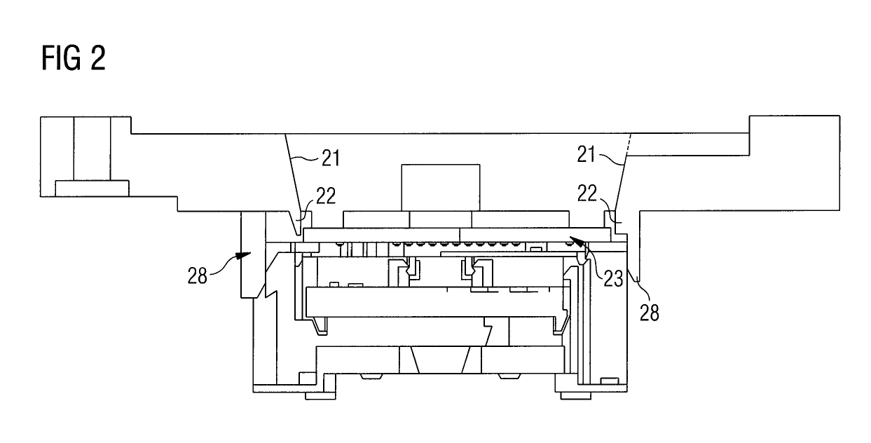

The loading machine has a loader head 1. In order to load a socket or adapter 12 with a corresponding component 11, the loader head 1 with the semiconductor component 11 (also see reference sign 23 in FIG. 2), which semiconductor component has been centred in a preceding step for orienting the semiconductor component and has been fixed to the loader head 1 by vacuum, is positioned above a socket or adapter 12 of a burn-in board.

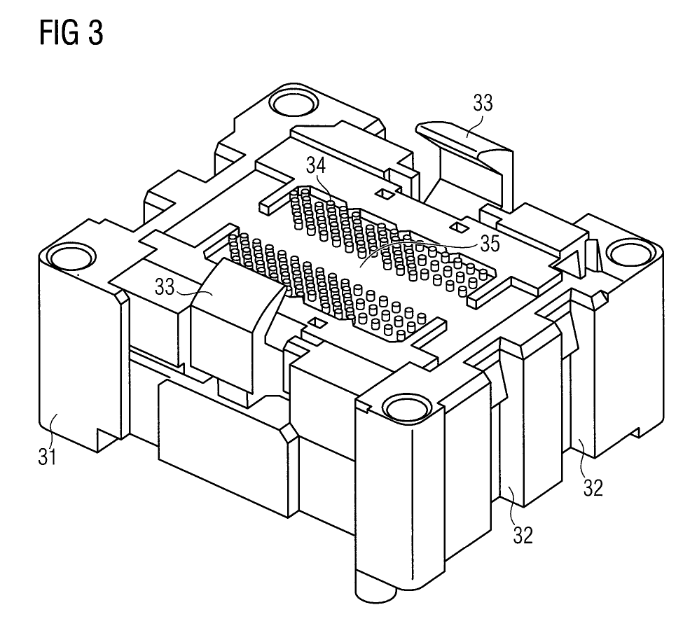

As emerges from FIG. 3, the adapters or sockets 12 in each case have only a basic element 31 but no cover (which is provided above a corresponding basic element 31 in the case of conventional (burn-in) sockets or adapters).

Furthermore, in an embodiment the adapters or sockets have no component insertion bevels or “guide” devices whatsoever. In order that the semiconductor component, in particular the electrical connecting contacts thereof, can nevertheless be guided and be inserted exactly into the socket and thus into the contact elements 34 in the socket or adapter, the loader head 1 has one or more guide elements 14 on its end facing the component. Said guide elements 14 can be fixed to the loader head 1 by means of holding elements 19. Holding elements with an arrangement of springs which afford a lateral and also vertical compensation possibility are suitable in particular for this purpose.

As emerges from FIGS. 1, 2 and 3, in the present exemplary embodiment grooves 32 may be provided in the basic element 31 of the socket or adapter and guide pins 18 (also see reference sign 28 in FIG. 2) may be provided on the guide element 14 (also see reference sign 2 in FIG. 2) in order to centre the loader head relative to the socket or adapter.

The grooves 32 may have an essentially U-shaped cross section, and extend at the outer edge of the basic element 31 from the top side perpendicularly downwards. The grooves 32 may reach as far as the underside of the basic element 31. The cross section of the grooves 32 may also have a different form, but must be able to ensure the guidance of the loader head.

If the loader head 1 is moved perpendicularly downwards, the guide pins 18 (also see reference sign 28 in FIG. 2) provided on the loader head are introduced into the respectively assigned grooves 32 of the socket or adapter 12. In order not to damage the filigree contact elements 34 (see FIG. 3) in the event of a faulty loading operation, spacer elements 22 (see FIG. 2) are arranged on the guide element 14 and prevent the guide element 14 from being placed inadvertently on the inner region 35 of the socket or adapter device.

Conventional sockets or adapters (in particular contacts and latches provided there) can be “opened” by depressing the adapter or socket cover, and can then be “closed” again after releasing the adapter or socket cover.

In the case of “coverless” sockets or adapters, this function of the cover (in particular the opening and closing of the abovementioned socket contacts and latches) is performed by the loader head 1, in particular by the special attachments 15 (only illustrated schematically here; also see reference sign 25 in FIG. 2) provided on the guide element 14 mounted upstream of the actual loader head.

Said attachments 15 (also see reference sign 25 in FIG. 2) are cutouts—as emerges from FIG. 1—in the guide element 14 (also see reference sign 2 in FIG. 2).

In this case, the vertical movement of the loader head, in particular of the attachments 15, can be converted into a corresponding horizontal movement or a corresponding horizontal movement (cf. FIG. 3) of correspondingly mechanical actuation devices by means of corresponding mechanical devices 33 (e.g. likewise having corresponding bevels) mounted or provided on the socket or adapter. With the aid of the mechanical actuation devices 33 (or by means of the movement thereof in the horizontal direction), the limbs of a contact element 34 of the socket or adapter, which contact element is (initially slightly) open upwardly, is prestressed in the direction of a “closed” position by means of corresponding spring devices and is coupled to the actuation device(s), can be correspondingly pulled apart (in the horizontal direction) and thus be prepared for receiving and for making electrical contact with a corresponding component or component housing connection.

The loader head 1 is advantageously moved downwards until the component 11, which is held fixed to the underside of the loader head—by the vacuum that continues to be maintained—and is centred by the guide element 14, touches the top side of the basic element 31 in the inner region 35 of the socket, and the connections of the component are introduced into the corresponding opened contact elements 34 of the socket or adapter; only then is the vacuum removed and the component released.

In other words, the component is on the one hand placed gently in the adapter or socket 12 by the loader head 1 and on the other hand is centred simultaneously, after the removal of the vacuum that holds the component fixed, by means of the directed guidance of the insertion bevels 21 in the guide element 2 (see FIG. 2) in such a way that the contact elements 34 of the socket or adapter can reliably receive the component housing connections. In order to be able to compensate for lateral and/or vertical offsets still present between the connecting contacts of the semiconductor component and the contact elements of the socket or adapter and thereby to avoid damage to the connecting contacts and/or the contact elements, the guide element or guide elements may be fixed in moveable fashion on that surface of the loader head which faces the socket or adapter. The holding elements for fixing the guide elements 14 may contain springs, for example.

In another embodiment of the method to load a socket the component is oriented with respect to the loader head with relatively high accuracy in a TBL (tested before load) test step by means of a centering device 16 which is arranged on the loader head and acts for example on the edges of the receptacle or adapter.

After the component has been placed in the socket 12, the loader head with the attachments 15 (also see reference signs 25 in FIG. 2) provided thereon and the guide element 14 is moved back upwards again in the perpendicular direction and the contact elements 34 provided there are thereby “closed” again by means of the mechanical actuation devices 33.

What is thereby achieved is that a reliable electrical contact is produced between electrical connecting contacts provided on the respective component and corresponding contact elements 34 provided on the adapter or socket 12.

In a correspondingly similar manner to that described above, a multiplicity of further adapters or sockets 12 (e.g. 30,000 per hour) can be loaded by the loader head 1 (or—if appropriate—further loader heads).

In each case a plurality of said sockets or adapters 12 may be interconnected in array form (e.g. 16*20 sockets) to form a test board (“burn-in board”).

The test board is in each case connected to a test unit—in a correspondingly conventional manner, e.g. by means of corresponding lines.

What is thereby achieved is that test signals output by the test unit are forwarded to the test board and from there to the sockets 12 by means of corresponding board contacts and socket connection pins (not illustrated here) that make contact with the latter.

From the sockets 12, the corresponding test signals are then forwarded via the abovementioned socket connections to the semiconductor components to be tested.

The signals output in reaction to the test signals input at semiconductor component contacts are then fed to the test unit and evaluated.

What is claimed is:

1. An apparatus for loading a first socket or adapter device with a semiconductor component, the first socket or adapter device having contact elements for making contact with the semiconductor component, the apparatus comprising one or more guide elements for producing an electrical contact between the semiconductor component and the contact elements of the first socket or adapter device.

2. The apparatus according to claim 1, wherein the one or more guide elements are fixed in moveable fashion by means of holding elements.

3. The apparatus according to claim 2, wherein the holding elements contain springs.

4. The apparatus according to claim 1, wherein the apparatus has guide pins which orient the apparatus during the loading of the first socket or adapter device in a defined position relative to the first socket or adapter device.

5. The apparatus according to claim 1, wherein the apparatus has spacer elements arranged in such a way that, for the one or more guide elements, a minimum distance from the contact elements of the first socket or adapter device is complied with.

6. The apparatus according to claim 1, wherein the one or more guide elements and the guide pins are arranged in such a way that the apparatus is also suitable for removing the semiconductor components from a second socket or adapter device, in particular a test before load station.

7. A socket or adapter device having guide elements, in particular grooves, for receiving the guide pins of the apparatus according to claim 2.

8. An array of interconnected sockets or adapter devices according to claim 7.

9. A method for loading a socket or adapter device with a semiconductor component, the socket or adapter device having contact elements for making contact with the semiconductor component by guiding the semiconductor component by at least one guide element of an apparatus to the socket or adapter device and contacting the semiconductor component and the socket or adapter device by means of the contact elements electrically.

10. The method according to claim 9, wherein the one or more guide elements are fixed in moveable fashion by means of holding elements.

11. The method according to claim 10, wherein the holding elements contain springs.

12. The method according to claim 9, wherein the apparatus is oriented by guide pins during the loading of the first socket or adapter device in a defined position relative to the first socket or adapter device.

13. The method according to claim 9, wherein for the one or more guide elements, a minimum distance from the contact elements of the first socket or adapter device is complied with by spacer elements.

14. The method according to claim 12, wherein the one or more guide elements and the guide pins are arranged in such a way that the apparatus is also suitable for removing the semiconductor components from a second socket or adapter device, in particular a test before load station.

15. A loader head for loading a first socket or adapter device with a semiconductor component, the first socket or adapter device having contact elements for making contact with the semiconductor component, the loader head comprising one or more guide elements for producing an electrical contact between the semiconductor component and the contact elements of the first socket or adapter device.

16. The loader head according to claim 15, wherein the one or more guide elements are fixed in moveable fashion by means of holding elements.

17. The loader head according to claim 16, wherein the holding elements contain springs.

18. The loader head according to claim 15, wherein the loader head has guide pins which orient the loader head during the loading of the first socket or adapter device in a defined position relative to the first socket or adapter device.

19. The loader head according to claim 15, wherein the loader head has spacer elements arranged in such a way that, for the one or more guide elements, a minimum distance from the contact elements of the first socket or adapter device is complied with.

20. The loader head according to claim 18, wherein the one or more guide elements and the guide pins are arranged in such a way that the loader head is also suitable for removing the semiconductor components from a second socket or adapter device, in particular a test before load station.
